(19) United States
(12) Patent Application Publication
(10) Pub. No.: US 2016/0122644 A1
(43) Pub. Date: May 5, 2016

(54) METHOD OF UNIFORMIZING OUTPUT LIGHT OF LIQUID CRYSTAL DISPLAY ELEMENT AND LIQUID CRYSTAL DISPLAY ELEMENT

(71) Applicants: TOKYO UNIVERSITY OF SCIENCE FOUNDATION, Tokyo (JP); DIC CORPORATION, Tokyo (JP)

(72) Inventors: Shunsuke Kobayashi, Tokyo (JP); Yukihide Shiraishi, Tokyo (JP); Naoki Toshima, Tokyo (JP); Mitsuhiro Akimoto, Tokyo (JP); Kenzo Takeishi, Kitaadachi-gun (JP); Haruyoshi Takatsu, Kitaadachi-gun (JP); Kunihiko Kotani, Kita-adachi-gun (JP)

(73) Assignees: TOKYO UNIVERSITY OF SCIENCE FOUNDATION, Tokyo (JP); DIC CORPORATION, Tokyo (JP)

(21) Appl. No.: 14/923,872

(22) Filed: Oct. 27, 2015

(30) Foreign Application Priority Data
Oct. 31, 2014 (JP) 2014-223427

(51) Int. Cl. C09K 19/02; C09K 19/54

(52) U.S. Cl. CPC C09K 19/02; C09K 19/54; C09K 2019/521

(57) ABSTRACT

The present invention provides a method of uniformizing output light from a liquid crystal display element and a liquid crystal display element in which output light is uniformized. The method of uniformizing output light of a liquid crystal display element includes: using a composition containing nanoparticles with an average particle diameter of 1 nm to 100 nm as a liquid crystal composition included in a liquid crystal layer in the liquid crystal display element having the liquid crystal layer interposed between a pair of substrates, and uniformizing light output from the liquid crystal display element. The present invention also provides a liquid crystal display element obtained by applying the method of uniformizing output light.

### TECHNICAL FIELD

The present invention relates to a method of uniformizing light output from a liquid crystal display element and a liquid crystal display element in which the output light is uniformized.

### BACKGROUND ART

A liquid crystal display element is formed to have a liquid crystal layer interposed between a pair of substrates and to include a liquid crystal composition in the liquid crystal layer. These liquid crystal display elements are widely used in an image display device such as a liquid crystal television, a monitor for a computer, a cellular phone, an information terminal machine, and a gaming machine.

Examples of the representative method of displaying a liquid crystal display element include a twisted nematic (TN) type, a super twisted nematic (STN) type, and an electrically controlled birefringence (ECB) type. In addition, in an active matrix-type liquid crystal display element using a thin film transistor (TFT), a VA type in which liquid crystal molecules are vertically aligned, an in-plane switching (IPS) type or an FFS type in which liquid crystal molecules are horizontally aligned, or the like, is employed.

Recently, in order to improve display quality, various studies for enabling these liquid crystal display elements to exhibit high contrast and fast response time have proceeded. For example, in order to increase a moving image displaying speed, until today, the present inventors have developed a technique using a liquid crystal composition obtained by mixing metal nanoparticles into liquid crystal molecules (see Patent Document 1). Further, the present inventors have reported a technique of reducing a threshold voltage in a liquid crystal electrooptic effect device (LC-EO device) having a nematic liquid crystal by using a liquid crystal composition obtained by mixing nanoparticles into liquid crystal molecules (see Non-Patent Document 1).

Meanwhile, light (output light) that penetrates a liquid crystal layer from a light source and is output from a liquid crystal display element is influenced by a liquid crystal layer or a structure that is adjacent to the liquid crystal layer, and thus in the same manner as above, output characteristics thereof also relate to the display quality of the liquid crystal display element. For example, if the interference of the output light with itself can be suppressed and the output light can be uniformized such that uniformity of spatial distribution increases, it is possible to further increase the display quality of the liquid crystal display element. However, until now, characteristics of this output light have rarely been reviewed.

### PRIOR ART DOCUMENTS

### Patent Documents

Patent Document 1: Japanese Unexamined Patent Application, First Publication No. 2005-148705

### Non-Patent Documents

Non-Patent Document 1: F. Haraguchi, et. al., Japanese Journal of Applied Physics, 2007, vol. 46, p. L796 to 797

### SUMMARY OF THE INVENTION

In view of these circumstances, the present invention is to provide a method of uniformizing output light from a liquid crystal display element and a liquid crystal element in which output light is uniformized.

The present inventors have diligently studied and entirely unexpectedly and firstly found out that uniformity of output light is dramatically increased by using a liquid crystal composition containing nanoparticles to complete the present invention.

That is, the present invention is to provide a method of uniformizing output light of a liquid crystal display element including: using a composition containing nanoparticles with an average particle diameter of 1 nm to 100 nm as a liquid crystal composition included in a liquid crystal layer in the liquid crystal display element having the liquid crystal layer interposed between a pair of substrates; and uniformizing light output from the liquid crystal display element.

In addition, the present invention provides a liquid crystal display element that is obtained by applying the method of uniformizing output light.

According to the present invention, there is provided a method of uniformizing output light from a liquid crystal display element and a liquid crystal display element in which output light is uniformized.

### BRIEF DESCRIPTION OF THE DRAWINGS

FIG. 1 is image data of an electrically controlled birefringence (ECB)-type liquid crystal cell used in Example 1 and Comparative Example 1.

FIG. 2 is enlarged image data of a surface of an electrically controlled birefringence (ECB)-type liquid crystal cell used in Example 1 and Comparative Example 1.

FIGS. 3A and 3B are image data of output light, in which FIG. 3A is image data of Comparative Example 1, and FIG. 3B is image data of Example 1.

FIGS. 4A and 4B are measurement results of the intensity distribution of output in which FIG. 4A is a measurement result in Comparative Example 1, and FIG. 4B is a measurement result in Example 1.

FIGS. 5A and 5B are graphs obtained by plotting the measurement results of the intensity distribution of output light, in which FIG. 5A is a graph of Comparative Example 1, and FIG. 5B is a graph of Example 1.

### DETAILED DESCRIPTION OF THE INVENTION

### <<Method of Uniformizing Output Light of Liquid Crystal Display Element>>

A method of uniformizing output light of a liquid crystal display element according to the present invention includes: using a composition containing nanoparticles with an average particle diameter of 1 nm to 100 nm as a liquid crystal composition included in a liquid crystal layer in the liquid crystal display element having the liquid crystal layer interposed between a pair of substrates; and uniformizing light (output light) output from the liquid crystal display element. According to the present invention, the uniformized output light refers to light that is emitted from a light source, penetrates a liquid crystal layer, and is output to the outside of a liquid crystal display element.

In the liquid crystal display element, the liquid crystal layer is formed by using, for example, means (enclosing means) such as a liquid crystal cell that encloses a liquid crystal composition. In this case, in the reflection-type liquid crystal, for example, if there is a regular structure such as a convex portion or a concave portion, or an irregular structure, in a light penetrating portion such as an external surface that faces a substrate of a liquid crystal cell or an inner surface of a liquid crystal composition enclosed position which is an opposite side of the external surface of the liquid crystal cell, light (output light) that penetrates the liquid crystal layer and is output from the liquid crystal display element is influenced by these structures such that uniformity decreases. It is that this is because the output light is diffracted by the structure, and interference occurs therebetween. Such non-uniformization of output light can be checked by, for example, observing a linear or spotted pattern when the output light is received on a screen.

In addition to the case described above, the non-uniformization of the output light in the liquid crystal display element occurs when a regular structure or an irregular structure exists in a member arranged adjacent to the liquid crystal cell in a contact or non-contact manner. For example, in a vertically aligned film such as polyimide used for vertically aligning liquid crystal molecules in a vertical alignment (VA)-type liquid crystal display element, generally, at the time of a rubbing treatment, an undesired irregular pattern is formed on the film surface, such that this becomes a cause of the non-uniformization of the output light.

In contrast, according to the present invention, the non-uniformization of the output light as described above is remarkably suppressed. The uniformization of the output light can be easily checked, for example, if a linear or spotted pattern is not observed, and a clear image is not observed except for a main image of the output light and vicinity thereof, when the output light is received on the screen.

According to the present invention, the reason in which the output light is uniformized is not clear, but it is supposed that the reason is because, if the liquid crystal composition contains nanoparticles, disorder occurs in an arrangement of the liquid crystal molecules, and thus the direction of polarized light is disordered, or a phase of scattered light is disordered such that interference of output light with itself is suppressed. The nanoparticles are dispersed in the liquid crystal composition without being precipitated, such that a remarkable uniformization effect of the output light can be obtained.

### <Liquid Crystal Composition>

The liquid crystal composition is not particularly limited as long as the liquid crystal composition contains nanoparticles in addition to the liquid crystal compound. A composition obtained by adding the nanoparticles such that the content thereof in a well-known liquid crystal composition becomes a predetermined content can be used.

### [Nanoparticles]

According to the present invention, the nanoparticles are not particularly limited, as long as the nanoparticles have an average particle diameter of 1 nm to 100 nm.

According to the present invention, the “average particle diameter” refers to a value of a particle diameter (D₅₀) in an integrated value 50% in a particle size distribution curve obtained by a laser diffraction scattering method.

It is preferable that the nanoparticles include an oxide, a semiconductor, or a composite thereof.

An example of the oxide includes metallic oxide, and specific examples thereof include silicon dioxide (SiO₂, silica), titanium oxide (TiO₂, titania), aluminum, oxide (Al₂O₃, alumina), zirconium oxide (ZrO₂, zirconia), zinc oxide (ZnO), barium titanate (BaTiO₃), and barium zirconate (BaZrO₃).

Examples of the semiconductor include cadmium selenide (CdSe), cadmium sulfide (CdS), zinc sulfide (ZnS), and tellurium copper (CuTe).

The nanoparticles including the oxide, the semiconductor, or the composite thereof means nanoparticles including the oxide, the semiconductor, or the composite thereof, and other components in addition thereto, and examples thereof include a particle including the oxide, the semiconductor, or the composite thereof, as a core, and the core is coated with other components, or include a particle which is subjected to a surface treatment.

Examples of the other components that coat the core include a host compound that can form an inclusion compound such as cyclodextrin (α-cyclodextrin, β-cyclodextrin, γ-cyclodextrin), a crown ether, cyclophane, and calixarene; and an oligomer or a polymer of a host compound obtained by coupling one or more types of the host compounds to each other.

The nanoparticles in which cores thereof are coated with the other components can be prepared in a well-known method, and a coating treatment may be performed, for example, by mixing the cores or precursors thereof and a component that coats the cores or precursors thereof and performing reaction, if necessary. Here, the “precursor of the component that coats the core” means a component in which a chemical structure changes by coating a core or a precursor thereof and which finally coats the core. In addition, the “precursor of the core” means a component in which a chemical structure changes by being coated with a component that coats a core or a precursor thereof and which is finally coated with the other component.

For example, nanoparticles which are metallic oxide coated with a polymer (polycyclodextrin) of cyclodextrin, can be prepared by a method of dissolving or dispersing metal alkoxide and polycyclodextrin in a solvent (dispersing medium) and performing reaction by heating. A reaction temperature, reaction time, and use amounts of materials (metal alkoxide and polycyclodextrin) may be appropriately adjusted such that the yield of the object increases. However, for example, the reaction temperature is preferably 200° C. to 300° C., and the reaction time is preferably 5 minutes to 60 minutes.

Examples of the surface treatment performed on the core include hydrophobization treatments such as alkyl silylation, dialkyl silylation, trialkyl silylation, dialkyl siloxanation, dialkyl polysiloxanation, aminoalkyl silylation, acryl silylation, methacryl silylation, alkylation, dialkylation, and trialkylation.

The surface treatment can be performed by causing a surface treatment agent to react with a reaction active group such as a hydroxyl group that exists on the surface of the core. For example, in the case of the hydrophobization treatment, a hydrophobic agent such as a silane coupling agent, silicone oil or silazane may be reacted with a reaction active group that exists on the surface of the core.

All of the oxide, the semiconductor, the composite thereof, and the other components that constitute the nanoparticles may be used singly, or two or more types thereof may be used.

The nanoparticles preferably include metallic oxide, more preferably metallic oxide coated with polycyclodextrin obtained by coupling cyclodextrin to each other, even more preferably zirconium oxide coated with polycyclodextrin obtained by coupling cyclodextrin to each other, and particularly preferably zirconium oxide coated with poly-γ-cyclodextrin.

The average particle diameter of the nanoparticles is 1 nm to 100 nm, and, if the average particle diameter is in this range, an effect of uniformizing the output light can be obtained.

Among them, the average particle diameter of the nanoparticles is preferably 10 nm to 90 nm, more preferably 20 nm to 80 nm, even more preferably 30 nm to 70 nm, and particularly preferably 40 nm to 50 nm. The nanoparticles having the average particle diameter in this range can be easily prepared, and also have a higher effect of uniformizing the output light.

The nanoparticles may be singly contained in the liquid crystal composition, or two or more types thereof may be contained. In this specification, if at least material properties of the nanoparticles are different from each other, the types of the nanoparticles are different.

With respect to the liquid crystal composition, the content of the nanoparticles is preferably 0.01% by mass to 1% by mass, more preferably 0.1% by mass to 0.9% by mass, and particularly preferably 0.3% by mass to 0.8% by mass. If the content of the nanoparticles is equal to or higher than the lower limit, the uniformization effect of the output light becomes higher. In addition, if the content of the nanoparticles is equal to or lower than the upper limit, dispersibility of the nanoparticles in the liquid crystal composition is further enhanced, and thus the uniformization effect of the output light becomes higher.

### [Liquid Crystal Compound]

The liquid crystal compound is not particularly limited, and a smectic liquid crystal compound, a nematic liquid crystal compound, a discotic liquid crystal compound, and the like can be used. Therefore, the liquid crystal compound may be a chiral liquid crystal compound or an a chiral liquid crystal compound.

Hereinafter, a nematic liquid crystal compound is described as an example.

### (Nematic Liquid Crystal Compound)

The nematic liquid crystal compounds are preferably compounds expressed by General Formula (LC) below.

R^{LC}A^{LC1}-Z^{LC}ₐA^{LC2}-Y^{LC} (LC)

(In General Formula (LC), R^{LC} represents an alkyl group having 1 to 15 carbon atoms, 1 or more CH₂ groups in the alkyl group may be substituted with —O—, —CH═CH—, —CO—, —OCO—, —COO—, or —C≡C— such that an oxygen atom is not directly adjacent thereto, 1 or more hydrogen atoms in the alkyl group may be arbitrarily substituted with a halogen atom,

each of A^{LC1} and A^{LC2} independently represents a group selected from the group of:

(a) a trans-1,4-cyclohexylene group (in the group, one CH₂ group or two or more CH₂ groups that are not adjacent to each other may be substituted with an oxygen atom or a sulfur atom);

(b) a 1,4-phenylene group (in this group, one CH group or two or more CH groups that are not adjacent to each other may be substituted with a nitrogen atom); and

(c) a 1,4-bicyclo(2.2.2)octylene group, a naphthalene-2,6-diyl group, a naphthalene-3,7-diyl group, a decahydronaphthalene-2,6-diyl group, a 1,2,3,4-tetrahydronaphthalene-2,6-diyl group, or a chroman-2,6-diyl group; but

each of the one or more hydrogen atoms included in the group (a), (b), or (c) may be substituted with a fluorine atom, a chlorine atom, CF₃, or OCF₃,

Z^{LC} represents a single bond, —CH═CH—, —CF═CF—, —C≡C—, —CH₂CH₂—, —(CH₂)₄—, —OCH₂—, —CH₂O—, —OCF₂—, —CF₂O—, —COO—, or —OCO—:

Y^{LC} represents a hydrogen atom, a fluorine atom, a chlorine atom, a cyano group, and an alkyl group having 1 to 15 carbon atoms, one or more CH₂ groups in the alkyl group may be substituted with —O—, —CH═CH—, —CO—, —OCO—, —COO—, —C≡C—, —CF₂O—, or —OCF₂— such that the oxygen atom is not directly adjacent thereto, the one or more hydrogen atoms in the alkyl group may be arbitrarily substituted with a halogen atom; and

a represents an integer of 1 to 4, but, if a represents 2, 3, or 4, and there are a plurality of A^{LC1}'s, the plurality of A^{LC1}'s may be identical to or different from each other, and if there are a plurality of Z^{LC}'s, the plurality of Z^{LC}'s may be identical to or different from each other.)

The compounds expressed by the General Formula (LC) above are preferably one or more types of compounds selected from the group consisting of compounds by General Formulae (LC1) and (LC2) below.

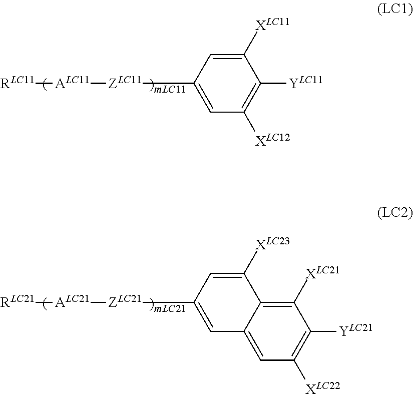

(in the formulae, each of R^{LC11} and R^{LC21} independently represents an alkyl group having 1 to 15 carbon atoms, one or more CH₂ groups in the alkyl group may be substituted with —O—, —CH═CH—, —CO—, —OCO—, —COO—, or —C≡C— such that an oxygen atom is not directly adjacent thereto, one or more hydrogen atoms in the alkyl group is arbitrarily substituted with a halogen atom, each of A^{LC11}, and A^{LC21} independently represents any one of structures below,

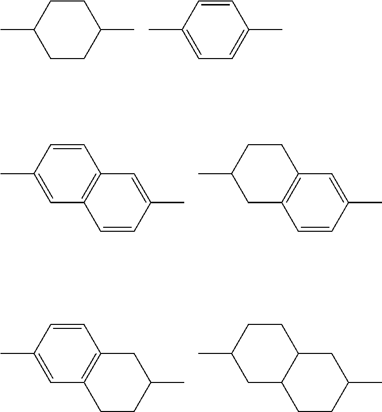

(in the structures, one or more CH₂ groups in a cyclohexylene group may be substituted with an oxygen atom, one or more CH groups in a 1,4-phenylene group may be substituted with a nitrogen atom, and one or more hydrogen atoms in the structure may be substituted with a fluorine atom, a chlorine atom, CF₃, or OCF₃.)

each of X^{LC11}, X^{LC12}, and X^{LC21} to X^{LC23} independently represents a hydrogen atom, a chlorine atom, a fluorine atom, CF₃, or OCF₃;

each of Y^{LC11} and Y^{LC21} independently represents a hydrogen atom, a chlorine atom, a fluorine atom, a cyano group, CF₃, OCH₂F, OCHF₂, or OCF₃;

each of Z^{LC11} and Z^{LC21} independently represents a single bond, —CH═CH—, —CF═CF—, —C≡C—, —CH₂CH₂—, —(CH₂)₄—, —OCH₂—, —CH₂O—, —OCF₂—, —CF₂O—, —COO—, or —OCO—;

each of m^{LC11} and m^{LC21} independently represents an integer of 1 to 4, and if there are plural A^{LC11}'s, A^{LC21}'s, Z^{LC11}'s, and Z^{LC21}'s, these may be identical to or different from each other).

Each of R^{LC11} and R^{LC21} is preferably independently an alkyl group having 1 to 7 carbon atoms, an alkoxy group having 1 to 7 carbon atoms, or an alkenyl group having 2 to 7 carbon atoms, more preferably an alkyl group having 1 to 5 carbon atoms, an alkoxy group having 1 to 5 carbon atoms, or an alkenyl group having 2 to 5 carbon atoms, and even more preferably has a straight chain shape and most preferably has a structure below, as an alkenyl group.

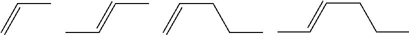

(in the formula, a right terminal is bonded to a ring structure.)

As each of A^{LC11} and A^{LC21}, independently, a structure as below is preferable.

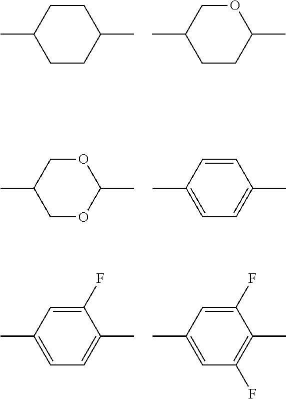

Each of Y^{LC11} and Y^{LC21} is preferably independently a fluorine atom, a cyano group, CF₃, or OCF₃, more preferably a fluorine atom or OCF₃, and particularly preferably a fluorine atom.

Independently, each of Z^{LC11} and Z^{LC21} is preferably a single bond, —CH₂CH₂—, —COO—, —OCO—, —OCH₂—, —CH₂O—, —OCF₂—, or —CF₂O—, more preferably a single bond, —CH₂CH₂—, —OCH₂—, —OCF₂—, or —CF₂O—, and particularly preferably a single bond, —OCH₂—, or —CH₂O—.

Independently, each of m^{LC11} and m^{LC21} is preferably 1, 2, or 3, preferably 1 or 2 storage stability and response speed at low temperatures are important, or is preferably 2 or 3 in order to improve the upper limit of nematic phase upper limit temperatures.

The compounds expressed by General Formula (LC1) are preferably one or more types of compounds selected from the group consisting of compounds expressed by General Formulae (LC1-a) to (LC1-c) below.

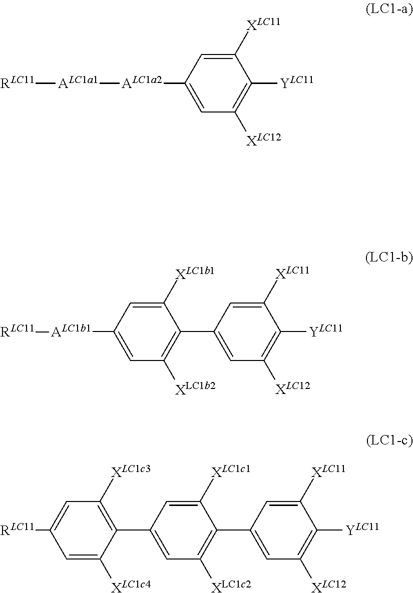

(in the formulae, each of R^{LC11}, Y^{LC11}, X^{LC11}, and X^{LC12} independently represents the same meaning as R^{LC11}, Y^{LC11}, X^{LC11}, and X^{LC12} in General Formula (LC1) above;

A^{LC1a1}, A^{LC1a2}, and A^{LC1b1} represent a trans-1,4-cyclohexylene group, a tetrahydropyran-2,5-diyl group, or a 1,3-dioxane-2,5-diyl group; and

each of X^{LC1b1}, X^{LC1b2}, and X^{LC1c1} to X^{LC1c4} independently represents a hydrogen atom, a chlorine atom, a fluorine atom, CF₃, or OCF₃.)

Each of R^{LC11}'s is preferably independently an alkyl group having 1 to 7 carbon atoms, an alkoxy group having 1 to 7 carbon atoms, or an alkenyl group having 2 to 7 carbon atoms, and more preferably an alkyl group having 1 to 5 carbon atoms, an alkoxy group having 1 to 5 carbon atoms, or an alkenyl group having 2 to 5 carbon atoms.

Each of X^{LC11} to X^{LC1c4} is preferably independently a hydrogen atom or a fluorine atom.

Each Y^{LC11} is preferably independently a fluorine atom, CF₃, or OCF₃.

The compounds expressed by General Formula (LC1) are preferably one or more types of compounds selected from the group consisting of compounds expressed by General Formulae (LC1-d) to (LC1-m).

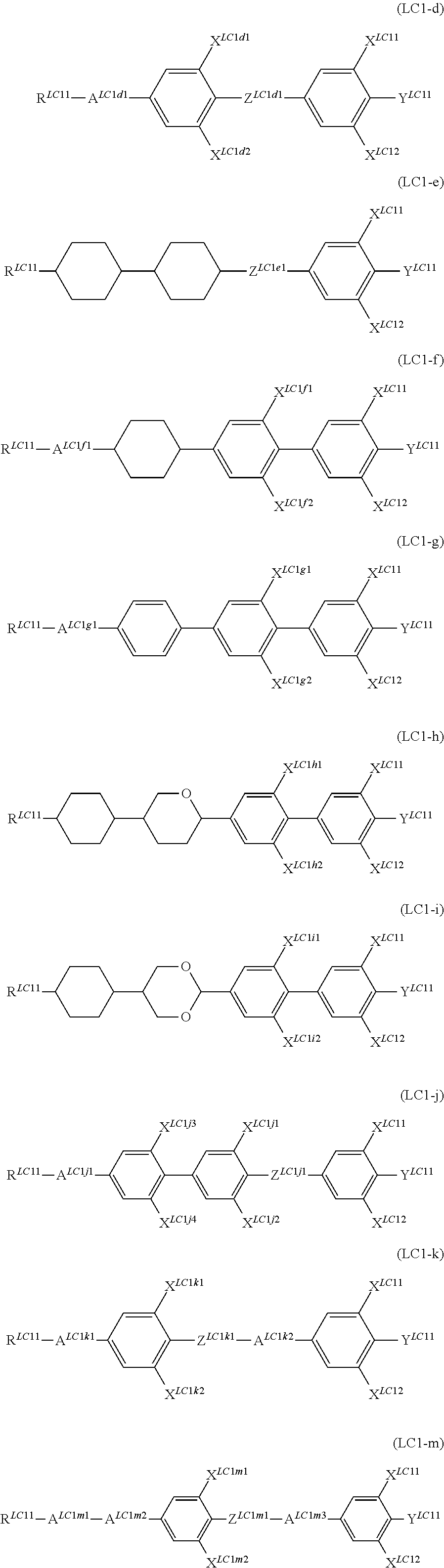

(in the formulae, each of R^{LC11}, Y^{LC11}, X^{LC11}, and X^{LC12} independently represents the same meaning as R^{LC11}, Y^{LC11}, X^{LC11}, and X^{LC12} in General Formula (LC1) above;

each of A^{LC1d1}, A^{LC1f1}, A^{LC1g1}, A^{LC1j1}, A^{LC1k1}, A^{LC1k2}, A^{LC1m1}, to A^{LC1m3} independently represents a 1,4-phenylene group, a trans-1,4-cyclohexylene group, a tetrahydropyran-2,5-diyl group, or a 1,3-dioxane-2,5-diyl group;
of X^{LC1d1}, X^{LC1d2}, X^{LC1f1}, X^{LC1f2}, X^{LC1g1}, X^{LC1g2}, X^{LC1h1}, X^{LC1h2}, X^{LC1i1}, X^{LC1i2}, X^{LC1j1} to X^{LC1j4}, X^{LC1k1}, X^{LC1k2}, X^{LC1m1}, and X^{LC1m2} independently represents a hydrogen atom, a chlorine atom, a fluorine atom, CF₃, or OCF₃; and

each of Z^{LC1d1}, Z^{LC1e1}, Z^{LC1j1}, Z^{LC1k1}, and Z^{LC1m1} independently represents a single bond, —CH═CH—, —CF═CF—, —C≡C—, —CH₂CH₂—, —(CH₂)₄—, —OCH₂—, —CH₂O—, —OCF₂—. —CF₂O—, —COO—, or —OCO—.)

R^{LC11} is preferably an alkyl group having 1 to 7 carbon atoms, an alkoxy group having 1 to 7 carbon atoms, or an alkenyl group having 2 to 7 carbon atoms, and more preferably an alkyl group having 1 to 5 carbon atoms, an alkoxy group having 1 to 5 atoms, or an alkenyl group having 2 to 5 carbon atoms.

Each of X^{LC11} to X^{LC1m2} is preferably independently a hydrogen atom or a fluorine atom.

Y^{LC11} is preferably a fluorine atom, CF₃, or OCF₃.

Each of Z^{LC1d1} to Z^{LC1m1} is independently —CF₂O— or —OCH₂—.

The compounds expressed by General Formula (LC2) are one or more types of compounds selected from the group consisting of compounds expressed by General Formulae (LC2-a) to (LC2-g) below.

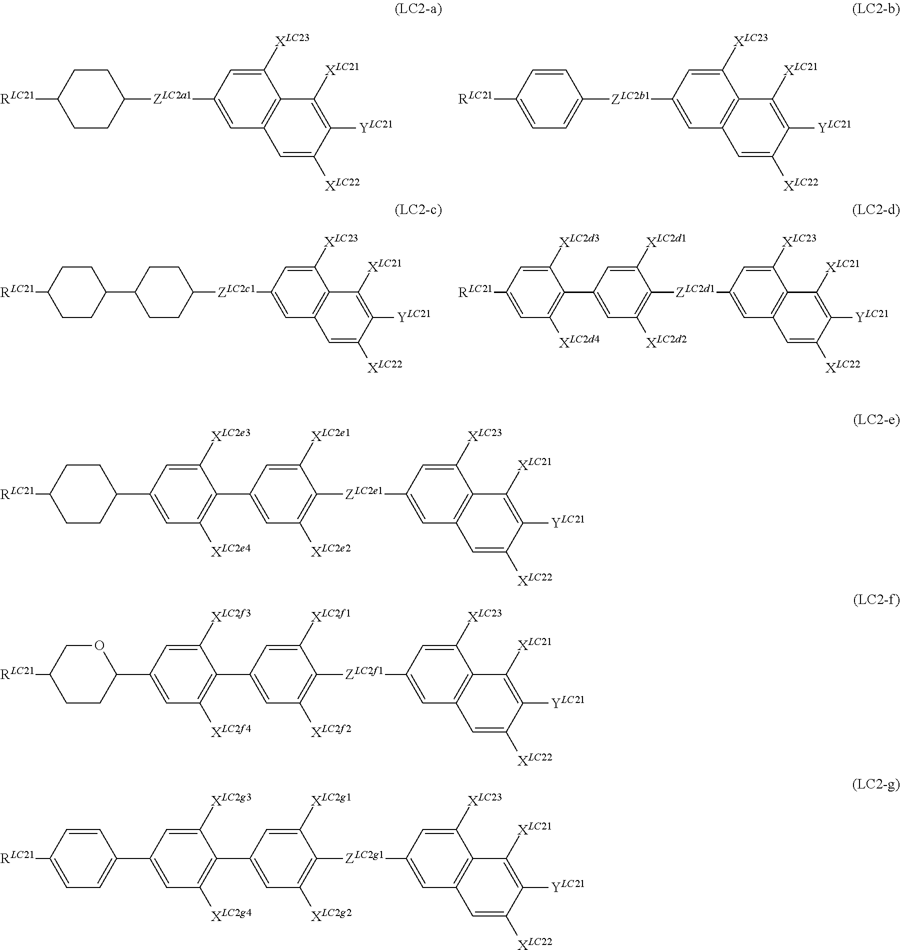

(in the formulae, each of R^{LC21}, Y^{LC21}, and X^{LC21} to X^{LC23} independently represents the same meaning as R^{LC21}, Y^{LC21}, and X^{LC21} to X^{LC23} in General Formula (LC2) above,

each of X^{LC2d1} to X^{LC2d4}, X^{LC2e1} to X^{LC2e4}, X^{LC2f1} to X^{LC2f4}, and X^{LC2g1} to X^{LC2g4} independently represents a hydrogen atom, a chlorine atom, a fluorine atom, CF₃, or OCF₃, and

each of Z^{LC2a1}, Z^{LC2b1}, Z^{LC2c1}, Z^{LC2d1}, Z^{LC2e1}, Z^{LC2f1}, and Z^{LC2g1} independently represents a single bond, —CH═CH—, —CF═CF—, —C≡C—, —CH₂CH₂—, —(CH₂)₄—, —OCH₂—, —CH₂O—, —OCF₂—, —CF₂O—, —COO—, or —OCO—.)

Each of R^{LC21}'s is preferably independently an alkyl group having 1 to 7 carbon atoms, an alkoxy group having 1 to 7 carbon atoms, or an alkenyl group having 2 to 7 atoms, and is more preferably an alkyl group having 1 to 5 carbon atoms, an alkoxy group having 1 to 5 carbon atoms, or an alkenyl group having 2 to 5 carbon atoms.

Each of X^{LC21} to X^{LC2g4} is preferably independently a hydrogen atom or a fluorine atom.

Y^{LC21} is preferably a fluorine atom, CF₃, or OCF₃.

Each of Z^{LC2a1} to Z^{LC2g4} is preferably independently —CF₂O— or —OCH₂—.

The compounds expressed by General Formula (LC) above are preferably one or more types of compounds selected from the group consisting of compounds expressed by General Formulae (LC3), (LC4), (LC4′), and (LC5).

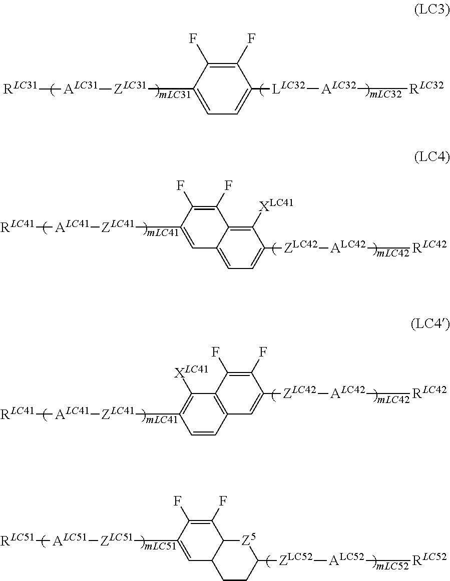

(in the formulae, each of R^{LC31}, R^{LC32}, R^{LC41}, R^{LC42}, R^{LC51}, and R^{LC52} independently represents an alkyl group having 1 to 15 carbon atoms, one or more CH₂ groups in the alkyl group may be substituted with —O—, —CH═CH—, —CO—, —OCO—, —COO—, or —C≡C— such that a oxygen atom is not directly adjacent thereto, and one or more hydrogen atoms in the alkyl group may be arbitrarily substituted with a halogen atom;

each of A^{LC31}, A^{LC32}, A^{LC41}, A^{LC42}, A^{LC51}, and A^{LC52} independently represents any one of structures below,

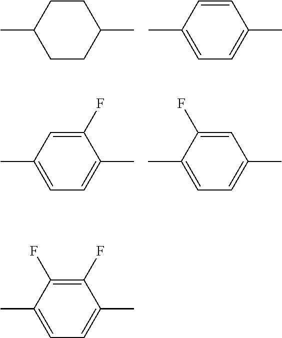

(in the structures, one or more CH₂ groups in a cyclohexylene group may be substituted with an oxygen atom, one or more CH groups in a 1,4-phenylene group may be substituted with a nitrogen atom, and one or more hydrogen atoms in the structure is substituted with a chlorine atom, CF₃, or OCF₃);

each of Z^{LC31}, Z^{LC32}, Z^{LC41}, Z^{LC42}, Z^{LC51}, and Z^{LC52} independently represents a single bond, —CH═CH—, —C≡C—, —CH₂CH₂—, —(CH₂)₄—, —COO—, —OCH₂—, —CH₂O—, —OCH₂CH₂—, —CH₂CH₂O—, —OCF₂—, or —CF₂O—;

Z⁵ represents a CH₂ group or an oxygen atom;

X^{LC41} represents a hydrogen atom or a fluorine atom;

each of m^{LC31}, m^{LC32}, m^{LC41}, m^{LC42}, m^{LC51}, and m^{LC52} independently represents 0 to 3, but if m^{LC31}+m^{LC32}, m^{LC41}+m^{LC42}, m^{LC51}+m^{LC52} are 1, 2, or 3, and, there are a plurality of A^{LC31}'s to A^{LC52}'s, and Z^{LC31}'s to Z^{LC52}'s, these may be identical to or different from each other.)

Each of R^{LC31} to R^{LC52} is preferably independently an alkyl group having 1 to 7 atoms, an alkoxy group having 1 to 7 carbon atoms, or an alkenyl group having 2 to 7 carbon atoms, and, the alkenyl group is most preferably expressed by the following structure;

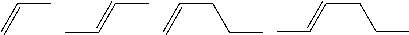

(in the formula, a right terminal is bonded to a ring structure.)

each of A^{LC31} to A^{LC52} is preferably independently the following structure, and

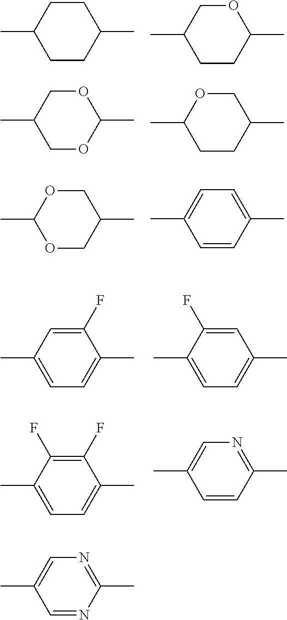

each of Z^{LC31} to Z^{LC51} is preferably independently a single bond, —CH₂O—, —COO—, —OCO—, —CH₂CH₂—, —CF₂O—, —OCF₂—, or —OCH₂—.

The compounds expressed by General Formula (LC3) are preferably one or more compounds selected from the group consisting of the compounds expressed by General Formulae (LC3-a) and (LC3-b).

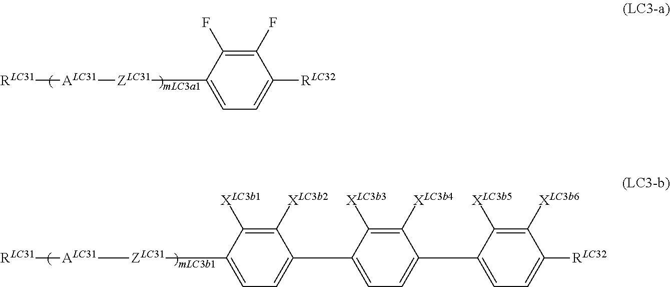

(in the formulae, each of R^{LC31}, R^{LC32}, A^{LC31}, and Z^{LC31} independently represents the same meaning as R^{LC31}, R^{LC32}, A^{LC31}, and Z^{LC31} in General Formula (LC3) above;

each of X^{LC3b1} to X^{LC3b6} independently represents a hydrogen atom or a fluorine atom, but at least one combination of X^{LC3b1} and X^{LC3b2} or X^{LC3b3} and X^{LC3b4} equally represents a fluorine atom;

m^{LC3a1} represents 1, 2, or 3, m^{LC3b1} represents 0 or 1, and if there are a plurality of A^{LC31}'s and Z^{LC31}'s, these may be identical to or different from each other.)

Each of R^{LC31} and R^{LC32} is preferably independently an alkyl group having 1 to 7 carbon atoms, an alkoxy group having 1 to 7 carbon atoms, an alkenyl group having 2 to 7 carbon atoms, or an alkenyloxy group having 2 to 7 carbon atoms.

A^{LC31} is preferably a 1,4-phenylene group, a trans-1,4-cyclohexylene group, a tetrahydropyran-2,5-diyl group, or 1,3-dioxane-2,5-diyl group, and more preferably a 1,4-phenylene group or a trans-1,4-cyclohexylene group.

Z^{LC31} is preferably a single bond, —CH₂O—, —COO—, —OCO—, or —CH₂CH₂—, and more preferably a single bond.

General Formula (LC3-a) preferably represents General Formulae (LC3-a1) to (LC3-a4) below.

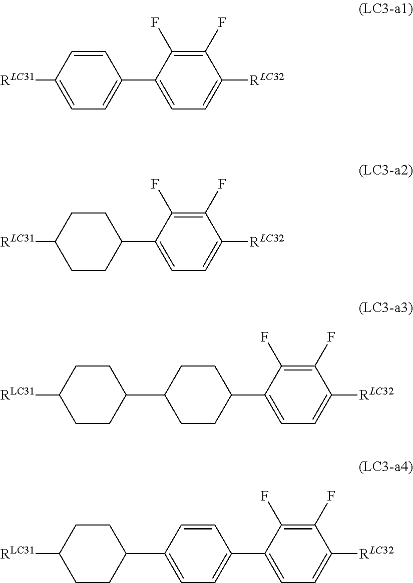

(in the formulae, each of R^{LC31} and R^{LC32} independently represents the same meaning as R^{LC31} and R^{LC32} in General Formula (LC3) above.)

It is preferable that each of R^{LC31} and R^{LC32} is independently an alkyl group having 1 to 7 carbon atoms, an alkoxy group having 1 to 7 carbon atoms, or an alkenyl group having 2 to 7 carbon atoms, and it is more preferable that R^{LC31} is an alkyl group having 1 to 7 carbon atoms, and R^{LC32} is an alkoxy group having 1 to 7 carbon atoms.

General Formula (LC3-b) preferably represents General Formulae (LC3-b1) to (LC3-b12) below, more preferably represents General Formula (LC3-b1), (LC3-b6), (LC3-b8), or (LC3-11), further preferably represents General Formula (LC3-b1) or (LC3-b6), and particularly preferably represents General Formula (LC3-b1).

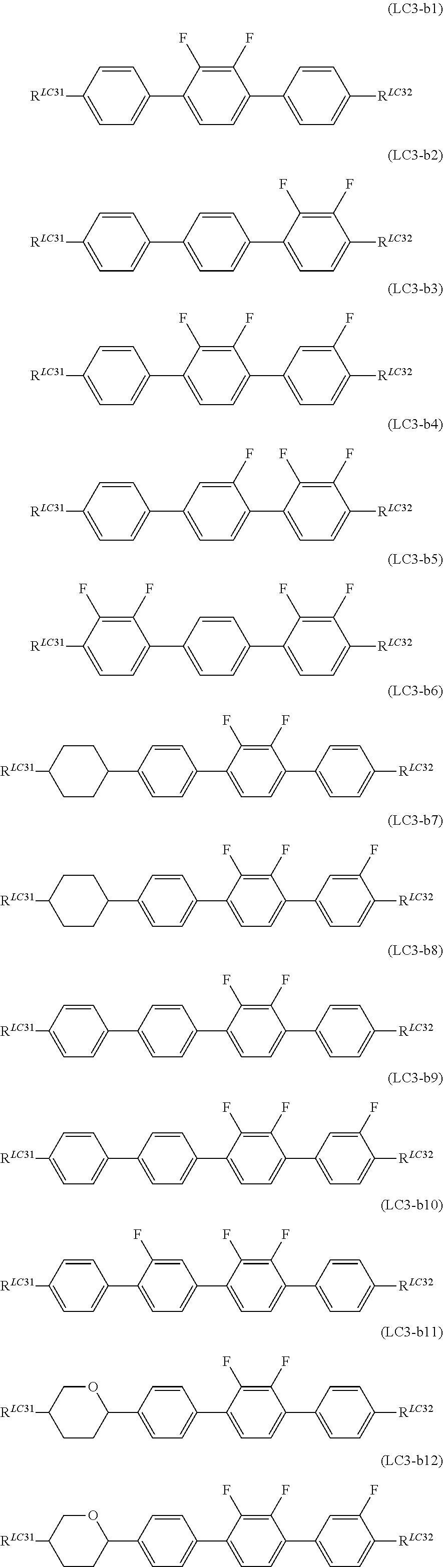

(in the formulae, each of R^{LC31} and R^{LC32} independently represents the same meaning as R^{LC31} and R^{LC32} in General Formula (LC3) above.)

It is preferable that each of R^{LC31} and R^{LC32} is independently an alkyl group having 1 to 7 carbon atoms, an alkoxy group having 1 to 7 carbon atoms, or an alkenyl group having 2 to 7 carbon atoms, and it is more preferable that R^{LC31} is an alkyl group having 2 or 3 carbon atoms, and R^{LC32} is an alkyl group having 2 carbon atoms.

The compounds expressed by General Formulae (LC4) and (LC4′) are preferably one or more types of compounds selected from the group consisting of compounds expressed by General Formulae (LC4-a) to (LC4-c) and (LC4′-d) below, and the compounds expressed by General Formula (LC5) are more preferably one or more types of compounds selected from the group consisting of compounds expressed by General Formulae (LC5-a) to (LC5-c) below.

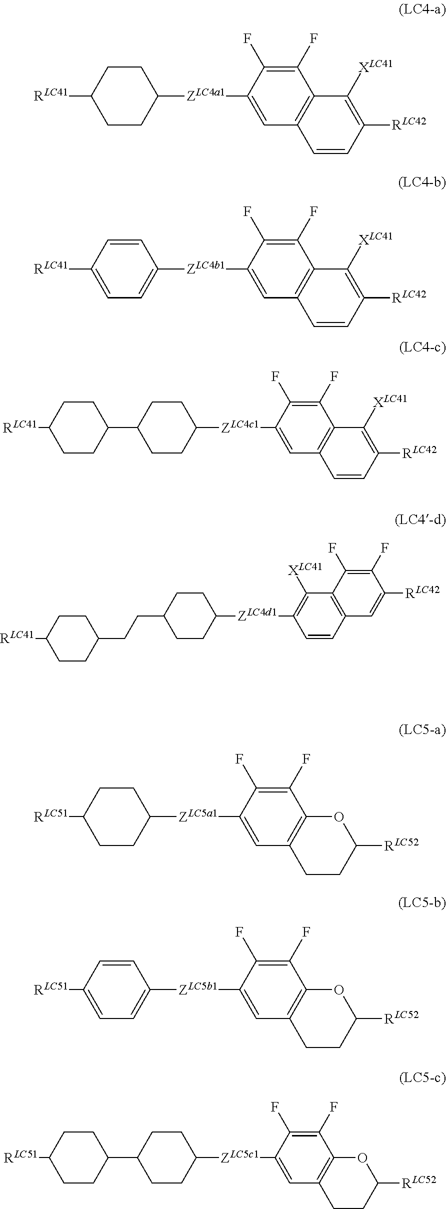

(in the formulae, each of R^{LC41}, R^{LC42}, and X^{LC41} independently represents the same meaning as R^{LC41}, R^{LC42}, and X^{LC41} in General Formulae (LC4) and (LC4′) above:

each of R^{LC51} and R^{LC52} independently represents the same meaning as R^{LC51} and R^{LC52} in General Formula (LC5) above; and

each of Z^{LC4a1}, Z^{LC4b1}, Z^{LC4c1}, Z^{LC4d1}, Z^{LC5a1}, Z^{LC5b1}, and Z^{LC5c1} independently represents a single bond, —CH═CH—, —C≡C—, —CH₂CH₂—, —(CH₂)₄—, —COO—, —OCH₂—, —CH₂O—, —OCH₂CH₂—, —CH₂CH₂O—, —OCF₂—, or —CF₂O—.)

Each of R^{LC41}, R^{LC42}, R^{LC51}, and R^{LC52} is preferably independently an alkyl group having 1 to 7 carbon atoms, an alkoxy group having 1 to 7 carbon atoms, an alkenyl group having 2 to 7 carbon atoms, or an alkenyloxy group having 2 to 7 carbon atoms.

Each of Z^{LC4a1} to Z^{LC5c1} is preferably independently a single bond, —CH₂O—, —COO—, —OCO—, or —CH₂CH₂—, and more preferably a single bond.

The compounds expressed by General Formula (LC) above are preferably one or more compounds selected from the group consisting of the compounds expressed by General Formula (LC6) below.

R^{LC61}-A^{LC61}-Z^{LC61}A^{LC62}-Z^{LC62}ₘ_{_{LC61}}A^{LC63}-R^{LC62} (LC6)

(in the formulae, each of R^{LC61} and R^{LC62} independently represents an alkyl group having 1 to 15 carbon atoms, one or more CH₂ groups in the alkyl group may be substituted with —O—, —CH═CH—, —CO—, —OCO—, —COO—, or —C≡C— such that an oxygen atom is not directly adjacent thereto, and one or more hydrogen atoms in the alkyl group is arbitrarily substituted with a halogen atom,

each of A^{LC61} to A^{LC63} independently represents any of the structures below,

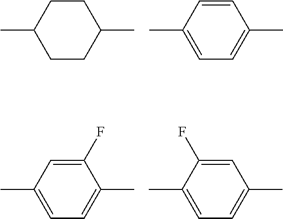

(in the structures, one or more CH₂CH₂ groups in the cyclohexylene group may be substituted with —CH═CH—, —CF₂O—, or —OCF₂—, and one or more CH groups in the 1,4-phenylene group may be substituted with the nitrogen atom.)

each of Z^{LC61} and Z^{LC62} independently represents a single bond, —CH═CH—, —C≡C—, —CH₂CH₂—, —(CH₂)₄—, —COO—, —OCH₂—, —CH₂O—, —OCF₂—, or —CF₂O—; and

mLC61 represents 0 to 3. However, the compounds expressed by General Formulae (LC1) to (LC5) above are excluded.)

Each of R^{LC61} and R^{LC62} independently represents an alkyl group having 1 to 7 carbon atoms, an alkoxy group having 1 to 7 carbon atoms, or an alkenyl group having 2 to 7 carbon atoms, and the alkenyl group most preferably represents the structures below.

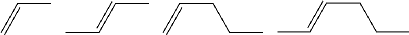

(in the formula, a right terminal is bonded to a ring structure)

Each of A^{LC61} to A^{LC63} is preferably independently one of the structures below, and

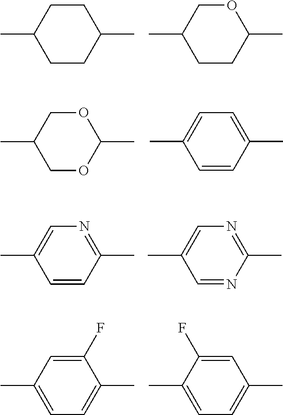

each of Z^{LC61} and Z^{LC62} is preferably independently a single bond, —CH₂CH₂—, —COO—, —OCH₂—, —CH₂O—, —OCF₂—, or —CF₂O—.

The compounds expressed by General Formula (LC6) are preferably one or more types of compounds selected from the group consisting of compounds expressed by General Formulae (LC6-a) to (LC6-m) below.

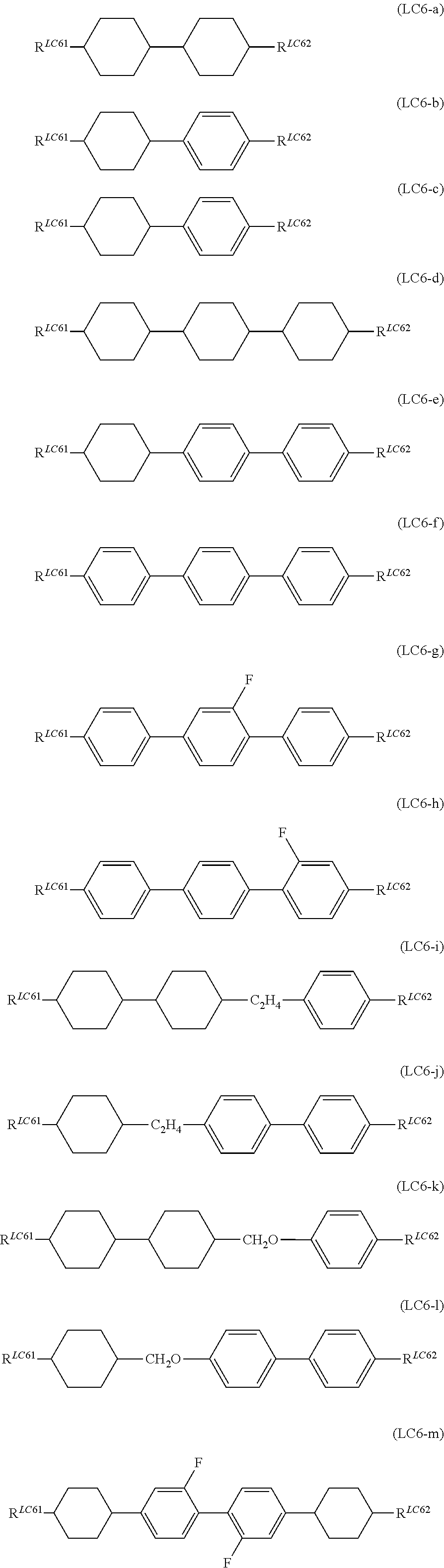

(in the formulae, each of R^{LC61} and R^{LC62} independently represents an alkyl group having 1 to 7 carbon atoms, an alkoxy group having 1 to 7 carbon atoms, an alkenyl group having 2 to 7 carbon atoms, or an alkenyloxy group having 2 to 7 carbon atoms.)

The liquid crystal compound may be contained in the liquid crystal composition singly, or two or more types thereof may be contained.

The content of the liquid crystal compound of the liquid crystal composition may be appropriately adjusted according to the types of the liquid crystal compound, and is not particularly limited.

### [Other Components]

In addition to the nanoparticles and the liquid crystal compound, the liquid crystal composition may contain other components that do not correspond thereto, and can be arbitrarily selected depending on the purpose thereof.

Examples of the other components include a chiral compound and a polymerizable compound, and the like.

Examples of the chiral compound include any one of a compound having an asymmetric atom, a compound having axial asymmetry, a compound having plane asymmetry, and an atropisomer, and any one of a compound having a polymerizable group and a compound not having a polymerizable group.

Examples of the polymerizable compound include a compound that stabilizes a liquid crystal composition.

The content of the other component of the liquid crystal composition may be appropriately adjusted depending on the type of the other components, and is not particularly limited.

### <<Liquid Crystal Display Element>>

The liquid crystal display element according to the present invention is the same as a well-known liquid crystal display element, except for having a composition containing the nanoparticles described above as the liquid crystal composition such that the output light is uniformized, a liquid crystal layer is interposed between a pair of substrates, and the liquid crystal layer has the liquid crystal composition.

For example, in the liquid crystal display element, at least one of the pair of the substrates is transparent an oriented film and an electrode are further provided on the substrate, orientation of liquid crystal molecules is controlled by applying electricity to the electrode, and a polarizing plate, a phase difference film, and the like are included, such that display can be performed by using the orientation state. For example, the thickness (the distance between the pair of substrates) of the liquid crystal layer is preferably 3 μm to 20 μm.

The liquid crystal display element can be applied to various operation modes such as TN, STN, ECB, VA, IPS, FFS, π cell, OCB, SSFLC, and Polymer-Stabilized V-FLCD.

The liquid crystal display element according to the present invention can be obtained by applying the uniformizing method of the output light according to the present invention described above. For example, when the liquid crystal layer is irradiated with light such as a laser, the liquid crystal display element is formed by using a liquid crystal layer which is confirmed that light (output light or transmitted light) penetrating the liquid crystal layer and being output is uniformized as the liquid crystal layer, such that a liquid crystal display element in which output light is uniformized can be effectively manufactured.

In the past, characteristics of the output light of the liquid crystal display element have not been reviewed, and there has been no effective means for uniformization of output light.

In contrast, according to the present invention, the output light of the liquid crystal display element is uniformized, and the uniformity of the spatial distribution of the output light becomes high. Therefore, the display quality of the liquid crystal display element can be enhanced.

In addition, according to the present invention, a light condensing rate of output light is enhanced by uniformizing the output light. This can be confirmed by the fact that the circumference of a main image of output light is brighter than the periphery of a screen and the vicinity thereof when the output light is received by the screen.

In addition, according to the present invention, it is possible to reduce an operation voltage of the liquid crystal display element. Generally, it is known that if a temperature of a liquid crystal composition increases, an arrangement of liquid crystal molecules is disordered, such that an operation voltage can be reduced. For example, it is known that an operation voltage can be reduced by about 5% in a temperature increase of 7° C. The reduction of the operation voltage according to the present invention is similar to the phenomenon at the time of the temperature increase, proves that disorder occurs in the arrangement of the liquid crystal molecules according to the present invention, and the nanoparticles are aligned to be dispersed to exhibit favorable uniformity in the liquid crystal composition. In addition, according to this decrease of the operation voltage, power consumption of the liquid crystal display element can be reduced.

### EXAMPLES

Hereinafter, with reference to examples, the present invention is described in detail, but the present invention is not limited by these examples.

### Example 1 and Comparative Example 1

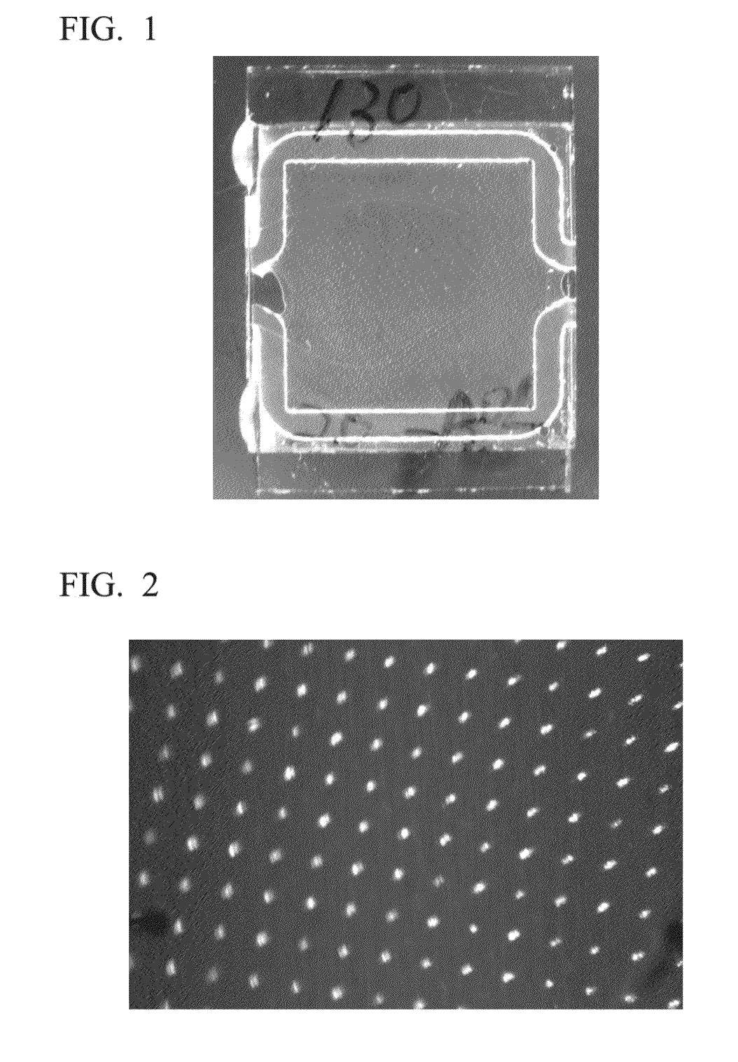

The electrically controlled birefringence (ECB)-type liquid crystal cell shown in FIG. 1 was used, and an uniformization effect of output light was confirmed in the following procedure. The liquid crystal cell has an enclosure position of the liquid crystal composition in a size of about 1 cm×about 1 cm×20 μm and an arrangement of regular dot-shaped small projections on a pair of external surfaces that face the substrate. Data obtained by capturing the surface of the liquid crystal cell in an enlarged manner is illustrated in FIG. 2. FIG. 2 is image data in which existence of projections is stressed by irradiation with light. As shown in FIG. 2, the dot-shaped projections are regularly arranged in intervals of about 1.2 μm in two directions intersecting to each other at almost right angle.

### Analysis of Output Light when Liquid Crystal Composition not Containing Nanoparticles is Used

### Comparative Example 1

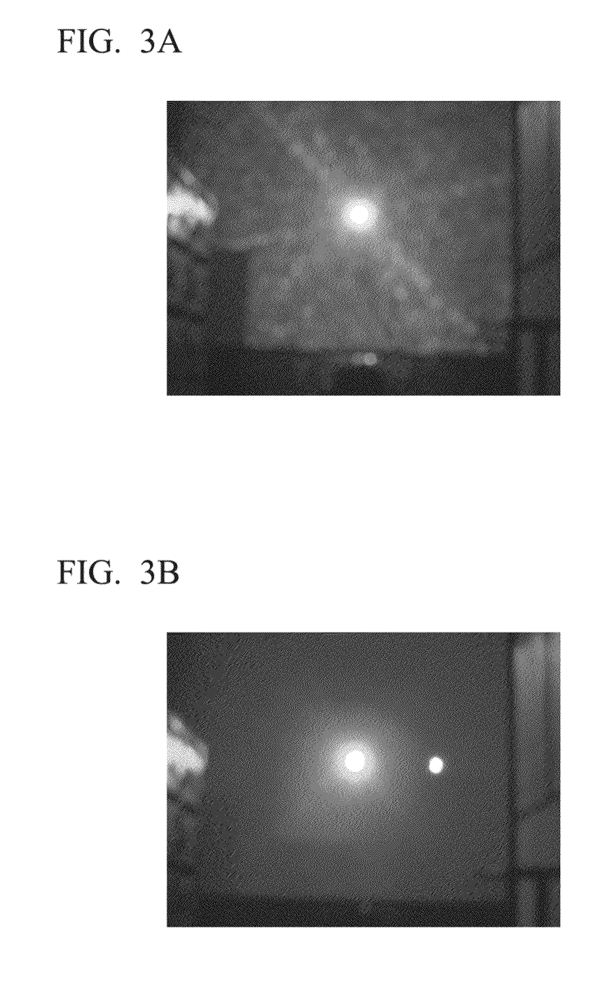

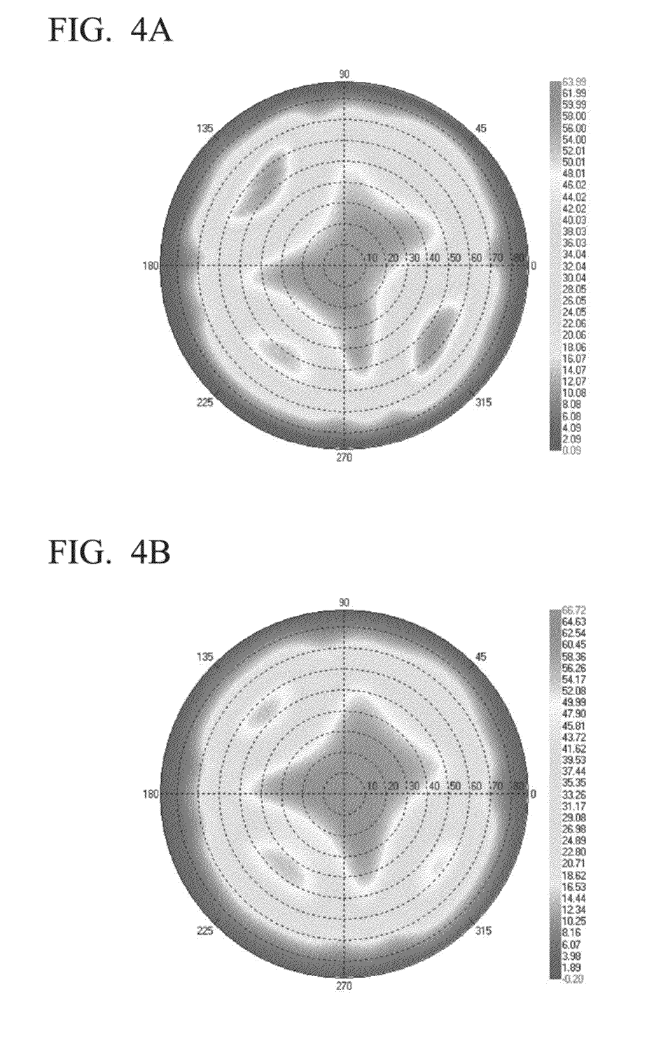

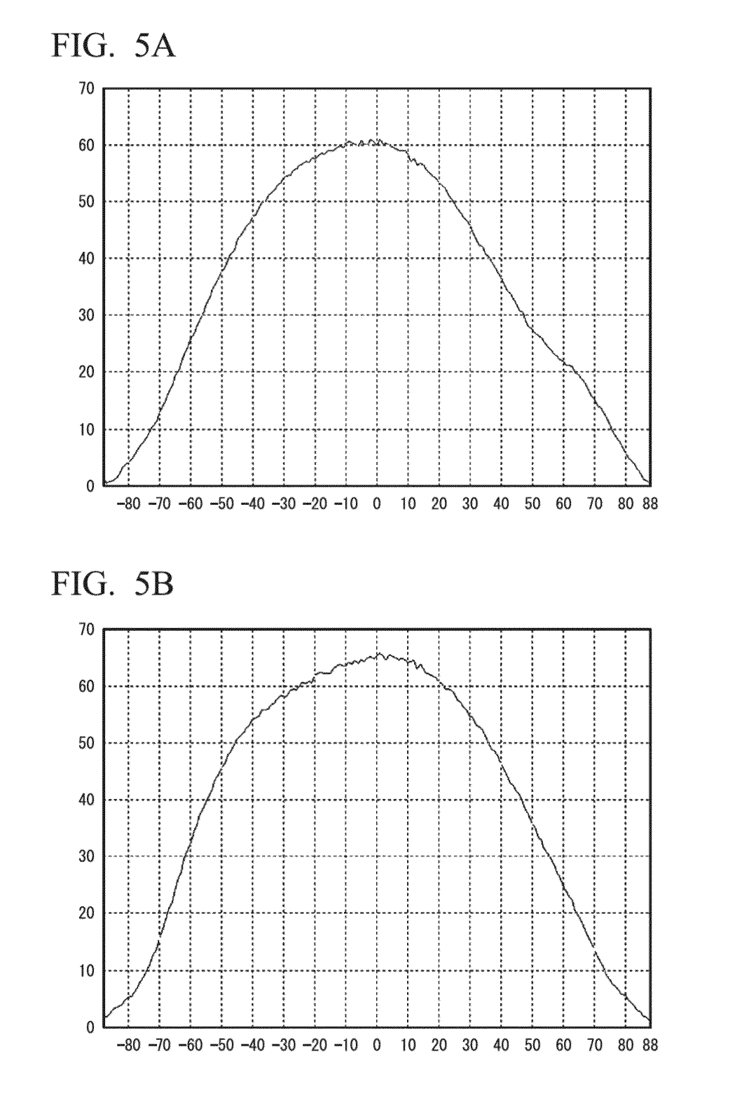

A nematic liquid crystal composition was enclosed in the liquid crystal cell, one external surface of the liquid crystal cell was irradiated with an argon laser from an external portion of the liquid crystal cell. Irradiation conditions of the argon laser at this point are as described below. The irradiation direction of the argon laser was approximately in a vertical direction with respect to the external surface of the liquid crystal cell. Also, light (output light or transmitted light) that penetrates the liquid crystal composition and was emitted from the external surface on the other side of the liquid crystal cell was received on a screen disposed so as to intersect at a right angle with a surface, in the traveling direction of the output light, separated by a distance of about 30 m from an external surface on the other side, and an image thereof was observed. Image data of the output light observed on the screen at this point is shown in FIG. 3A. In addition, with respect to this output light, intensity distribution was measured by using an optical measuring device (“EZ-contrast, XL-88” manufactured by ELDIM). The measurement results thereof were shown in FIG. 4A, and a graph obtained by plotting the measurement results thereof was shown in FIG. 5A, respectively. In addition, in FIGS. 5A and 5B, a vertical axis indicates an intensity of output light and a horizontal axis indicates a position of a measurement area in a diameter direction illustrated in FIGS. 4A and 4B.

### (Irradiation Condition of Argon Laser)

An argon laser was irradiated in conditions of a wavelength of 488 nm and an output of 20 mW by using “LGK 7872 M” manufactured by Lasos Lasertechnik GmbH as an irradiation apparatus.

As shown in FIG. 3A, as an image of output light, in addition to a main image (white portion) of the output light seen near the center of a screen, spotted and linear patterns which were considered as a cause of the intervention were widely formed.

In addition, as clearly seen in FIGS. 3A and 4A, in addition to the circumference of the main image (white portion) of the output light seen near the center of the screen, a comparatively bright image was widely dispersed, and thus it was confirmed that the output light was dispersed in addition to a portion near the center of the screen.

As described above, the spatial distribution of the output light was scattered, and thus the output light had low uniformity.

### Analysis of Output Light when Liquid Crystal Composition Containing Nanoparticles was Used

### Example 1

Except that a liquid crystal composition containing 0.75% by mass of zirconium oxide coated with poly-γ-cyclodextrin as nanoparticles was used as the nematic liquid crystal composition, in addition to the above, the output light was analyzed in the same method as in Comparative Example 1. The nanoparticles were particles in which the surface of zirconium oxide was coated with a polymer in which γ-cyclodextrin was crosslinked with each other, and in which an average particle diameter was 40 nm to 50 nm, and the nanoparticles were prepared according to a method described below. The image data of the output light observed on the screen at this point is shown in FIG. 3B. In addition, the measurement result of the intensity distribution of the output light is shown in FIG. 4B, and a graph obtained by plotting the measurement results is shown in FIG. 5B, respectively.

### (Preparation of Nanoparticles)

Zirconium (IV) ethoxide (Zr(OCH₂CH₃)₄) (0.14 mmol) and methanol (15 mL) were added to a 50-mL flask and stirred for 1 hour, so as to obtain a mixture (A).

Meanwhile, after poly-γ-cyclodextrin (0.014 mmol), water (15 mL) were added to a 300-mL flask and stirred for 1 hour, triethylene glycol (185 mL) was further added and stirred for 30 minutes, so as to obtain a mixture (B).

Subsequently, after the mixture (A) was added to the mixture (B) and stirred for 30 minutes, reaction was performed by using an ultrasonic-microwave homogenizer, so as to obtain zirconium oxide coated with poly-γ-cyclodextrin as nanoparticles. The reaction performed by using the ultrasonic-microwave homogenizer was performed in the condition described below.

Temperature rising speed: 21.5° C./min

Temperature rising time: 10 minutes

Reaction temperature: 240° C.

Reaction time (holding time of reaction temperature): 30 minutes

As shown in FIG. 3B, in the image of the output light, all spotted patterns observed in Comparative Example 1 and considered to be caused by the interference disappeared and most of linear patterns also disappeared. In addition, in FIG. 3B, a similar sized image (white portion) is seen on the right side of the main image (white portion) of the output light seen near the center of the screen, but this is an image of a helium-neon laser applied for comparison in order to decide a position of the image of the output light described above on the screen, and does not influence the results of this analysis.

In addition, as clearly seen in FIGS. 3B and 4B, the circumference of the main image (white portion) of the output light seen near the center of the screen was remarkably brighter than the periphery of the screen and the vicinity thereof and thus it was confirmed that the output light was concentrated near the center of the screen. From FIGS. 5A and 5B, the intensity of the output light seen near the center of the screen in Example 1 was about twice that in Comparative Example 1, and thus it was proven that the output light in Example 1 was remarkably concentrated near the center than that in Comparative Example 1.

In this manner, the spatial distribution of the output light had high uniformity and the output light had extremely high uniformity.

From the results of Example 1 and Comparative Example 1, it was found that the output light was able to be uniformized by using a composition containing nanoparticles as the liquid crystal composition, and it was confirmed that the same effect was able to be obtained in the liquid crystal display element.

1. A method of uniformizing output light of a liquid crystal display element, comprising:
using a composition containing nanoparticles with an average particle diameter of 1 nm to 100 nm as a liquid crystal composition included in a liquid crystal layer in the liquid crystal display element having the liquid crystal layer interposed between a pair of substrates; and
uniformizing light output from the liquid crystal display element.

2. The method of uniformizing output light of a liquid crystal display element according to claim 1,
wherein the nanoparticles include metallic oxide.

3. The method of uniformizing output light of a liquid crystal display element according to claim 2,
wherein the nanoparticles are zirconium oxide coated with polycyclodextrin.

4. The method of uniformizing output light of a liquid crystal display element according to claim 1,
wherein a content of the nanoparticles of the liquid crystal composition is 0.01% by mass to 1% by mass.

5. The method of uniformizing output light of a liquid crystal display element according to claim 1,
wherein the average particle diameter of the nanoparticles is 30 nm to 60 nm.

6. The method of uniformizing output light of a liquid crystal display element according to claim 1,
wherein nanoparticles are dispersed in the liquid crystal composition.

7. A liquid crystal display element obtained by applying the method of uniformizing output light according to claim 1.

8. The method of uniformizing output light of a liquid crystal display element according to claim 2,
wherein a content of the nanoparticles of the liquid crystal composition is 0.01% by mass to 1% by mass.

9. The method of uniformizing output light of a liquid crystal display element according to claim 3,
wherein a content of the nanoparticles of the liquid crystal composition is 0.01% by mass to 1% by mass.

10. The method of uniformizing output light of a liquid crystal display element according to claim 2,
wherein the average particle diameter of the nanoparticles is 30 nm to 60 nm.

11. The method of uniformizing output light of a liquid crystal display element according to claim 3,
wherein the average particle diameter of the nanoparticles is 30 nm to 60 nm.

12. The method of uniformizing output light of a liquid crystal display element according to claim 4,
wherein the average particle diameter of the nanoparticles is 30 nm to 60 nm.

13. The method of uniformizing output light of a liquid crystal display element according to claim 2,
wherein nanoparticles are dispersed in the liquid crystal composition.

14. The method of uniformizing output light of a liquid crystal display element according to claim 3,
wherein nanoparticles are dispersed in the liquid crystal composition.

15. The method of uniformizing output light of a liquid crystal display element according to claim 4,
wherein nanoparticles are dispersed in the liquid crystal composition.

16. The method of uniformizing output light of a liquid crystal display element according to claim 5,
wherein nanoparticles are dispersed in the liquid crystal composition.

17. A liquid crystal display element obtained by applying the method of uniformizing output light according to claim 2.

18. A liquid crystal display element obtained by applying the method of uniformizing output light according to claim 3.

19. A liquid crystal display element obtained by applying the method of uniformizing output light according to claim 4.

20. A liquid crystal display element obtained by applying the method of uniformizing output light according to claim 5.
